(19) United States
(12) Patent Application Publication
(10) Pub. No.: US 2014/0080476 A1
(43) Pub. Date: Mar. 20, 2014

(54) METHOD FOR INTERFERENCE COORDINATION OF FEMTOCELLS, FEMTOCELL AND USER TERMINAL EQUIPMENT

(71) Applicant: ALCATEL LUCENT, Paris (FR)

(72) Inventors: Qi Jiang, Shanghai (CN); Gang Shen, Shanghai (CN)

(73) Assignee: ALCATEL LUCENT, Paris (FR)

(21) Appl. No.: 14/114,609

(22) PCT Filed: Apr. 25, 2012
(86) PCT No.: PCT/IB2012/000986

§ 371 Date: Oct. 29, 2013

(30) Foreign Application Priority Data
Apr. 29, 2011 (CN) 201110112238.X

(51) Int. Cl. H04W 16/14

(52) U.S. Cl. CPC H04W 16/14
USPC 455/422.1

(57) ABSTRACT

The present invention proposes a femtocell interference coordination method, a femtocell and a user terminal equipment in a macro-femtocell deployment scenario. The key point of this invention is to stimulate a user terminal of the macrocell to initiate a random access request to a femtocell defined by a “closed subscriber group”. Based on this, the femtocell will know there is a user that can not be detected by the macrocell and then trigger corresponding interference coordination operation to ensure that the user terminal equipment of the macrocell can at least receive information of control channels correctly.

### FIELD OF THE INVENTION

The present invention relates to the mobile communication filed, and more specifically, to a method for inter-cell interference coordination in the mobile communication field.

### BACKGROUND OF THE INVENTION

Recently, experiment networks for the Long Term Evolution (LTE for short) system of the mobile communication network has begun to be deployed all around the world, and it is about to provide services to the masses in the near future. In a LTE wireless network, in addition to traditional macrocells, microcells, there may also be deployed a number of picocells, femtocells, wireless relays and various other wireless network access nodes whose transmitting powers and coverage ranges are significantly varied. Introduction of such new nodes makes the future network a heterogeneous network with various kinds of wireless access nodes competing for wireless resources, which has a topology structures more complex than that of a traditional homogeneous network. This forms a totally new wireless interference environment.

The femtocells may significantly improve indoor coverage of the LTE system in that it may provide users with excellent access services. A femtocell has three work modes: open mode, closed mode and mixed mode. As a private device, a user generally will choose the closed mode for it, that is to say, only authorized users such as family members, party members are permitted to access. These authorized users are named as “closed subscriber group” (CSG for short). However, a user equipment terminal for a macrocell is unable to connect to a femtocell defined by a “closed subscriber group”. A cell covered by a femtocell is called a CSG cell as compared to a macro cell covered by a macro base station. Since the users may independently adjust the transmitting powers of femtocells, independently change positions of femtocells, and arbitrarily open or close the femtocells, the interferences between CSG cells and macrocells become an important interference scenario in the LTE system.

A general macro-femto deployment scenario in the LTE system is shown in FIG. 1. A femtocell is deployed in the coverage region of a macrocell. When a user terminal of the macrocell moves into the coverage range of the femtocell, the user equipment terminal of the macrocell is unable to connect to the femtocell defined by a “closed subscriber group” in this scenario since the femtocell is a private device. Therefore, for the user equipment terminal of the macrocell, there will be a “dead zone” in which control and data channels are unable to be detected.

As mentioned above, the inter-cell interference problem in the LTE network is always an important consideration in this industry. The LTE international standard has proposed some inter-cell interference coordination technologies whose basic ideas are all to perform physical resource allocation coordination between adjacent cells in order to reduce inter-cell interferences as much as possible. In particular, these technologies can be categorized into time domain solutions, power control solutions and frequency domain solutions. The key point in the time domain solutions is to coordinate utilization of time domain resources between the interfering nodes and the interfered nodes to make them orthogonal. The power control solutions reduce the interference level by adjusting the transmitting powers of the interfering nodes and the interfered nodes. The frequency domain solutions avoid interferences by configuring orthogonal frequency resources for the physical resources occupied by the control channels. So far, all interference coordination methods such as power control and time domain resource allocation for the macrocell-femtocell deployment scenario are all based on the measurement by users. However, since the user terminal of the macrocell is unable to connect to the femtocell set to the closed mode in this scenario, there will be a “dead zone” in which control and data channels are unable to be detected by the user terminal of the macrocell. This problem will become worse especially when the user terminal of the macrocell is powered on after moving into the dead zone, since it is unable to detect the change of the channel quality of the serving cell and thus it is unable to trigger the interference coordination between the femtocell and the macrocell. In this case, the user terminal of the macrocell will not be able to communicate with the femtocell unless the user terminal goes out of the dead zone.

In view of the problem existed in the interference coordination technologies in the macrocell-femtocell deployment scenario of a LTE system, the invention proposes an enhanced inter-cell interference coordination method. With this method, the femtocell can identify presence of user terminal of the macrocell and then trigger a method for power control and time domain resource allocation.

### SUMMARY OF THE INVENTION

The present invention proposes a femtocell interference coordination method, a femtocell and a user terminal equipment in a macro-femtocell deployment scenario. The key point of this invention is to stimulate a user terminal of a macrocell to initiate a random access request to a femtocell defined by a “closed subscriber group”. Based on this, the femtocell will know there is a user that can not be detected by the macrocell and then trigger corresponding interference coordination operation to ensure that the user terminal equipment of the macrocell can at least receive information of control channels correctly.

In particular, according to an embodiment of the present invention, there is provided a method for interference coordination by a femtocell, wherein there is at least one user terminal of a macrocell within coverage of the femtocell. The method comprises:

the femtocell receiving a random access request initiated by the user terminal of the macrocell;

the femtocell estimating path loss between the femtocell and the user terminal of the macrocell; and

the femtocell performing interference coordination to ensure that the user terminal of the macrocell can receive information of control channels correctly.

According to a specific embodiment of the present invention, the femtocell receiving a random access request initiated by the user terminal of the macrocell further comprises:

synchronizing the user terminal of the macrocell to the femtocell;

the user terminal of the macrocell receiving system information of the femtocell, system information of the femtocell indicating that the user terminal of the macrocell can access the femtocell; and

the user terminal of the macrocell initiating the random access request to the femtocell.

According to a specific embodiment of the present invention, the femtocell receiving a random access request initiated by the user terminal of the macrocell further comprises:

updating information settings of “whitelist of closed subscriber groups” of the user terminal of the macrocell to comprise all femtocells that potentially cause interferences to the user terminal of the macrocell;

synchronizing the user terminal of the macrocell to the femtocell; and

the user terminal of the macrocell initiating the random access request to the femtocell.

According to a specific embodiment of the present invention, the femtocell receiving a random access request initiated by the user terminal of the macrocell further comprises:

synchronizing the user terminal of the macrocell to the femtocell; and

the user terminal of the macrocell receiving an instruction from a user to initiate the random access request to the femtocell.

According to a specific embodiment of the present invention, a BOOLEAN information indication of csg-indication in information block 1 of the system information of the femtocell is set to be “FALSE”.

According to a specific embodiment of the present invention, the information settings of “whitelist of closed subscriber groups” of the user terminal of the macrocell is obtained through information from a network side, or obtained through empirical information of a user terminal side, and it is updated through a radio resource control connection.

According to a specific embodiment of the present invention, the femtocell estimates the path loss between the femtocell and the user terminal of the macrocell based on a default transmitting power value of the user terminal of the macrocell.

According to a specific embodiment of the present invention, the femtocell performs the interference coordination based on power control or time domain resource allocation.

According to a specific embodiment of the present invention, the femtocell performs the interference coordination based on the path loss between the femtocell and the user terminal of the macrocell and the path loss between the femtocell and the macrocell estimated by the femtocell.

According to a specific embodiment of the present invention, there is provided a method for initiating a random access to a femtocell by a user terminal, wherein the user terminal is a user terminal of a macrocell and is located in coverage area of the femtocell, and the user terminal of the macrocell is an unauthorized user terminal for the femtocell. The method comprises:

the user terminal obtaining information allowing initiation of a random access request to the femtocell; and

the user terminal initiating the random access request to the femtocell.

According to a specific embodiment of the present invention, the user terminal obtaining information allowing initiation of a random access request to the femtocell includes: the user terminal receiving system information from the femtocell, the system information of the femtocell indicating that the user terminal of the macrocell can access the femtocell.

According to a specific embodiment of the present invention, the user terminal obtaining information allowing initiation of a random access request to the femtocell includes: information settings of “whitelist of closed subscriber groups” of the user terminal of the macrocell comprising all femtocells that potentially cause interferences to the user terminal of the macrocell.

According to a specific embodiment of the present invention, the user terminal obtaining information allowing initiation of a random access request to the femtocell includes: the user terminal receiving from a user an instruction which instructs the user equipment to initiate the random access request to the femtocell.

According to a specific embodiment of the present invention, a BOOLEAN information indication of csg-indication in information block 1 of the system information of the femtocell is set to be “FALSE”.

According to a specific embodiment of the present invention, the information settings of “whitelist of closed subscriber groups” of the user terminal of the macrocell is obtained through information from a network side, or obtained through empirical information of a user terminal side, and it is updated through a radio resource control connection.

According to a specific embodiment of the present invention, there is provided a femtocell, where there is at least one user terminal of a macrocell within coverage range of the femtocell. The femtocell comprises:

a synchronizing unit configured to receive synchronization information from the user terminal of the macrocell within the coverage range of the femtocell;

a receiving unit configured to receive a random access request initiated from the user terminal of the macrocell;

a path loss estimating unit configured to estimate path loss from the user terminal of the macrocell to the femtocell and path loss from the macrocell to the femtocell; and

an interference coordination unit configured to perform interference coordination to ensure that the user terminal of the macrocell can receive information of control channels correctly.

According to a specific embodiment of the present invention, the path loss estimating unit estimates the path loss between the femtocell and the user terminal of the macrocell based on a default transmitting power value of the user terminal of the macrocell.

According to a specific embodiment of the present invention, the interference coordination unit performs the interference coordination based on power control or time domain resource allocation.

According to a specific embodiment of the present invention, the interference coordination unit performs the interference coordination based on the path loss between the femtocell and the user terminal of the macrocell and the path loss between the femtocell and the macrocell estimated by the femtocell.

According to a specific embodiment of the present invention, the femtocell further includes a system information setting unit configured to set the system information, the system information indicating that the user terminal of the macrocell can access the femtocell.

According to a specific embodiment of the present invention, a BOOLEAN information indication of csg-indication in information block 1 of the system information is set to be “FALSE” by the system information setting unit.

According to a specific embodiment of the present invention, there is provided a user terminal equipment which is within coverage range of a femtocell. The user terminal equipment comprises:

a detecting unit configured to detect whether initiation of a random access request is allowed; and

a random access request initiating unit configured to initiate the random access request to the femtocell when the detecting unit outputs information allowing initiation of a random access request.

According to a specific embodiment of the present invention, the user terminal equipment further includes a first receiving unit configured to receive system information from the femtocell; and the detecting unit detects the system information from the femtocell and outputs to the random access request initiating unit the information allowing initiation of a random access request once it detects that the system information from the femtocell indicates that the user terminal of the macrocell can access the femtocell.

According to a specific embodiment of the present invention, the user terminal equipment further comprises a closed subscriber group whitelist storage unit configured to store whitelist of closed subscriber groups; settings of the closed subscriber group whitelist storage unit is updated to comprise all femtocells that potentially cause interferences to the user terminal of the macrocell; and when the detecting unit detects that the whitelist of closed subscriber groups includes all femtocells that potentially cause interferences to the user terminal of the macrocell, it outputs to the random access request initiating unit the information allowing initiation of a random access request.

According to a specific embodiment of the present invention, the user terminal equipment further comprises a second receiving unit configured to receive from a user an instruction which instructs the user equipment to initiate the random access request to the femtocell; and when the detecting unit detects the instruction which instructs the user equipment to initiate the random access request to the femtocell, it outputs to the random access request initiating unit the information allowing initiation of a random access request.

According to a specific embodiment of the present invention, a BOOLEAN information indication of csg-indication in information block 1 of the system information of the femtocell is set to be “FALSE”.

According to a specific embodiment of the present invention, the information settings of the whitelist of closed subscriber groups of the user terminal of the macrocell is obtained through information from a network side, or obtained through empirical information of a user terminal side, and it is updated through a radio resource control connection.

The other features and advantages of the present invention will become more apparent after reading the detailed description of the embodiments of the invention in conjunction with the accompanying drawings.

### BRIEF DESCRIPTION OF THE DRAWINGS

The accompanying drawings illustrated herein are to provide a further understanding of the invention and to constitute a part of the application. The schematic embodiments of the invention and the description thereof are to explain the invention and not to constitute an unsuitable limitation to the invention. In the accompanying drawings:

FIG. 1 illustrates a macrocell-femtocell deployment scenario in the LTE system.

FIG. 2 illustrates a schematic view of the process of the femtocell interference coordination according to an embodiment of the present invention.

FIG. 3 illustrates a structural schematic view of a femtocell according to an embodiment of the present invention.

FIG. 4 illustrates a structural schematic view of a user terminal equipment according to an embodiment of the present invention.

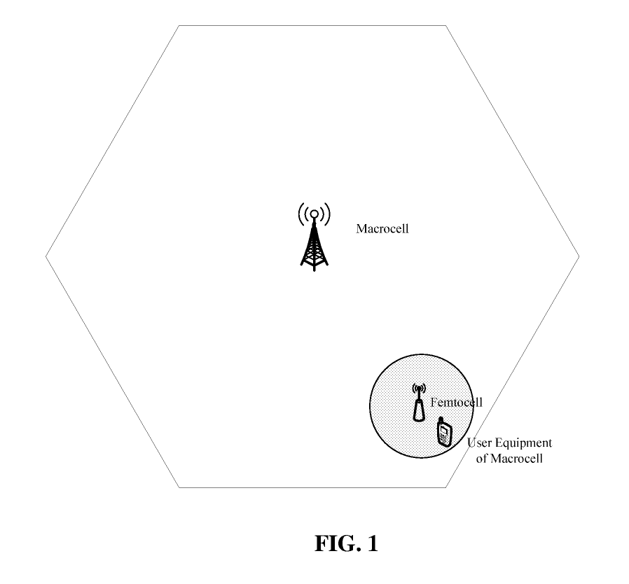

### DETAILED DESCRIPTION OF THE INVENTION

Specific embodiments of the present invention will now be explained in detail in conjunction with the accompanying drawings.

For a scenario in which a user terminal equipment of macrocell is powered on after moving into the dead zone, the present invention presents three methods to trigger the user terminal equipment of the macrocell to initiate a random access to a femtocell so as to trigger the femtocell to perform interference coordination processing.

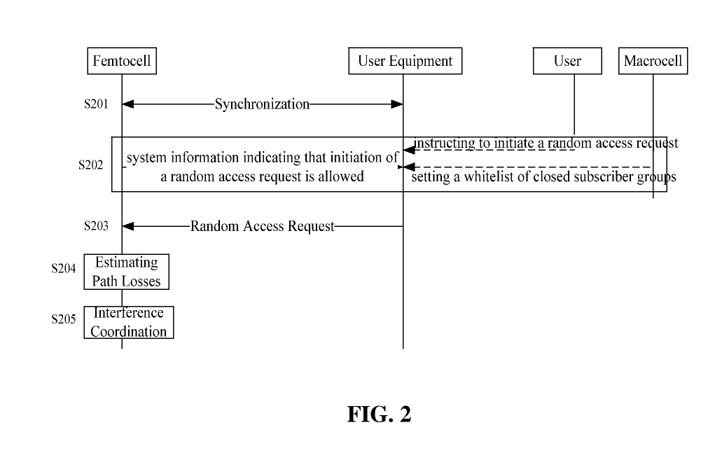

Detailed descriptions are set out hereinafter in conjunction with FIG. 2.

In step S201, the user terminal equipment of the macrocell is synchronized to the femtocell after powered on. After that, in step S202, any one of the following three methods may be used to trigger the user terminal equipment of the macrocell to initiate a random access to the femtocell.

1. The femtocell sets parameters in its system information to allow user terminals of the macrocell, i.e. unauthorized user equipments, to initiate random access to the femtocell. By way of a specific example, in the system information of the current 3GPP LTE-A system, a BOOLEAN information indication of “csg-indication” in the system information block 1(SIB-1) is used to indicate rules of cell access for user equipments. If the information is set to be “TRUE”, the user can only access a cell of closed subscriber group whose closed subscriber group ID is consistent with his whitelist of closed subscriber groups. If the information is set to be “FALSE”, there is no limitation to the access. Therefore, when the user equipment of the macrocell is synchronized to the femtocell, the femtocell sets the csg-indication in the system information block 1 to be “FALSE”, and sends to the user terminal of the macrocell the system information block 1 with the csg-indication set to be “FALSE”. When the user terminal of the macrocell received the above said information block 1, perform step S203 to initiate the random access to the femtocell.

2. The default information of “closed subscriber groups” is set to include all femtocells that may potentially cause interferences to the user equipment of the macrocell.

This method sets information of the “whitelist of closed subscriber groups” for the user equipment of the macrocell to include all femtocells that may potentially cause interferences to the user equipment of the macrocell. Since the “whitelist of closed subscriber groups” is controlled by non-access layers (at network side), it is required to define a new default “whitelist of closed subscriber groups” to be stored in the user equipment of the macrocell through non-network layer information. This process may be performed by the network side or the user equipment side and may be updated through the most recent radio resource control (RRC) connection. When a cell access is completed by the user equipment of the macrocell, the default “whitelist of closed subscriber groups” may be updated to more effective information, such as not including all femtocells that may potentially cause interferences to the user terminal of the macrocell.

3. Triggering a manual access to the “closed subscriber group”.

Using this method, after the user equipment of the macrocell has detected the femtocell, the user equipment of the macrocell may proceed according to an instruction from the user which instructs the user equipment of the macrocell to initiate a manual random access request to the femtocell. This manual random access request is not restricted by the “whitelist of closed subscriber groups”.

In step S203, the user equipment of the macrocell initiates the random access request to the femtocell, and the femtocell receives the random access request from the user equipment of the macrocell.

It should be emphasized here that it is not the intention of the various methods above to let the user equipment of the macrocell actually access the femtocell, but only to trigger the user equipment of the macrocell to initiate a random access request to the femtocell. It is the femtocell side that decides whether to permit the user equipment of the macrocell to access eventually. It is possible that the femtocell does not permit the user equipment of the macrocell to access. However, the triggering of this random access request may make the femtocell discover the existence of such a user equipment of the macrocell which is within a dead zone, and therefore, the following interference coordination operations may be performed.

In step S204, the femtocell estimates path losses, including the path loss from the user equipment of the macrocell to the femtocell and the path loss from the macrocell to the femtocell. The femtocell estimates the path loss between the femtocell and the user terminal of the macrocell based on a default transmitting power value of the user terminal of the macrocell.

In step S205, the femtocell performs the interference coordination. Based on information of the two path losses obtained by the femtocell at step S204, the existing enhanced interference coordination algorithms may be adopted by the femtocell, such as performing interference coordination through power control or time domain resource allocation.

1. Power Control

The femtocell will perform interference coordination according to reference signal receiving power and information of path loss.

2. Time Domain Resource Allocation

The femtocell may determine the existence of the dead zone through a coordination with the macrocell, and arrange the time domain resource allocation to implement the interference coordination. Based on this, a BOOLEAN information used for confirming the user equipment of the macrocell should be defined between the femtocell and the macrocell.

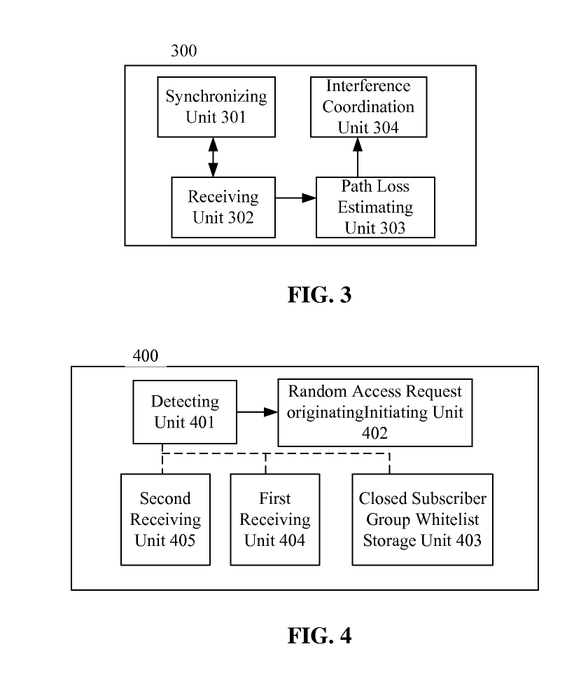

FIG. 3 illustrates a structural schematic view of a femtocell according to an embodiment of the present invention. In the embodiment, the femtocell 300 includes a synchronizing unit 301, a receiving unit 302, a path loss estimating unit 303 and an interference coordination unit 304.

In particular, the synchronizing unit 301 is configured to receive synchronization information from user terminals of the macrocell within the coverage range of the femtocell. The receiving unit 302 is configured to receive a random access request initiated by a user terminal of the macrocell. The path loss estimating unit 303 is configured to estimate the path loss from the user terminal of the macrocell to the femtocell. The interference coordination unit 304 is configured to perform interference coordination to ensure that the user terminal of the macrocell may receive information of control channels correctly.

In the path loss estimating unit 303, the femtocell estimates the path loss between the femtocell and the user terminal of the macrocell based on a default transmitting power value of the user terminal of the macrocell.

The interference coordination unit 304 performs the interference coordination based on the path loss between the femtocell and the user terminal of the macrocell and the path loss between the femtocell and the macrocell estimated by the femtocell. The interference coordination is achieved through power control or time domain resource allocation described in step S205. In particular:

1. Power Control

The interference coordination unit 304 performs interference coordination according to reference signal receiving power and information of path loss.

2. Time Domain Resource Allocation

The femtocell 300 may determine the existence of the dead zone through a coordination with the macrocell, and the interference coordination unit 304 arranges the time domain resource allocation to implement the interference coordination. Based on this, BOOLEAN information used for confirming the user equipment of the macrocell should be defined between the femtocell and the macrocell.

Furthermore, if the system settings select a mode in which the femtocell sets parameters in its system information to allow the user terminal of the macrocell, i.e. an unauthorized user equipment, to initiate a random access to the femtocell, the femtocell 300 may further include a system information setting unit configured to set the system information, where the system information indicates that the user terminal of the macrocell can access the femtocell. In the system information of the current 3GPP LTE-A system, a BOOLEAN information indication of “csg-indication” in the system information block 1(SIB-1) is used to indicate rules of cell access for user equipments. If the information is set to be “TRUE”, the user can only access a cell of closed subscriber group whose closed subscriber group ID is consistent with his whitelist of closed subscriber groups. If the information is set to be “FALSE”, there is no limitation to the access. Therefore, when the user equipment of the macrocell is synchronized to the femtocell, the femtocell sets the csg-indication in the system information block 1 to be “FALSE”. The femtocell sends to the user terminal of the macrocell the system information block 1 with the csg-indication set to be “FALSE”.

As mentioned above, it is not the intention of the invention to let the user equipment of the macrocell acturally access the femtocell, but only to trigger the user terminal equipment of the macrocell to initiate a random access request to the femtocell. It is the femtocell side that decides whether to permit the user equipment of the macrocell to access. It is possible that the femtocell does not permit the user equipment of the macrocell to access. However, the triggering of this random access request may make the femtocell discover the existence of such a user equipment of the macrocell which is within a dead zone and therefore, the following interference coordination operations can be performed.

FIG. 4 illustrates a structural schematic view of a user terminal equipment according to an embodiment of the present invention. In the embodiment, the user terminal equipment 400 includes a detecting unit 401, a random access request initiating unit 402, and may further include any one of a closed subscriber group whitelist storage unit 403, a first receiving unit 404 and a second receiving unit 405 according to various system arrangements.

In particular, the detecting unit 401 is configured to detect whether initiation of a random access request is allowed.

The random access request initiating unit 402 is configured to initiate the random access request to the femtocell when the detecting unit outputs an information allowing initiation of a random access request.

The closed subscriber group whitelist storage unit 403 is configured to store the “whitelist of closed subscriber groups”. The closed subscriber group whitelist storage unit is set to update information of the “whitelist of closed subscriber groups” to include all femtocells that may potentially cause interferences to the user terminal of the macrocell. When the detecting unit detects that the “whitelist of closed subscriber groups” includes all femtocells that may potentially cause interferences to the user terminal of the macrocell, it outputs to the random access request initiating unit the information allowing initiation of a random access request. Since the “whitelist of closed subscriber groups” is controlled by non-access layers (at network side), it is required to define a new default “whitelist of closed subscriber groups” to be stored in the user equipment of the macrocell through non-network layer information. This process may be performed by the network side or the user equipment side and may be updated through the most recent radio resource control (RRC) connection. When a cell access is completed by the user equipment of the macrocell, the default “whitelist of closed subscriber groups” may be updated to more effective information, such as not including any femtocells that may potentially cause interferences to the user terminal of the macrocell.

The first receiving unit 404 is configured to receive system information from the femtocell. The detecting unit 401 detects the system information from the femtocell and outputs to the random access request initiating unit the information allowing initiation of a random access request once it detects that the system information from the femtocell indicates that the user terminal of the macrocell can access the femtocell. As a specific example, a BOOLEAN information indication of “csg-indication” in the information block 1 of the system information of the femtocell is set to be “FALSE”.

The second receiving unit 405 is configured to receive from a user an instruction which instructs the user equipment to initiate the random access request to the femtocell. When the detecting unit 401 detects the instruction which instructs the user equipment to initiate the random access request to the femtocell, it outputs to the random access request initiating unit the information allowing initiation of a random access request.

Until now, no solution in the prior arts has directed to the problem of powering on of a user equipment of the macrocell in a dead zone. In this invention, we have presented an enhanced inter-cell interference coordination solution for the case in which the user equipment of the macrocell is powered on in the dead zone. With this method, the femtocell can confirm the existence of the user equipment of the macrocell and then trigger the power control or time domain resource allocation solutions to ensure that the user terminal of the macrocell will receive information of control channels correctly. This enables the user equipment of the macrocell to communicate with the macrocell smoothly after being powered on in the dead zone.

The present invention may be implemented in hardware, software, firmware or the combination thereof. Those skills in this art may appreciate that the present invention may be embodied in a computer program product arranged on a signal carrying media used by any suitable data processing systems. The signal carrying media may be transmission media or recordable media for machine readable information, including magnetic media, optical media or any other suitable media. Examples of recordable media include magnetic disk or soft disk in a hard drive, optical disk for optical drive, tape or other media that can be conceived by those skills in this art. Those skills in this art may appreciate that any communication devices with suitably programmed means will be able to perform the steps of the invention as embodied in a program product.

It should be understood from the above description that various embodiments of the invention can be modified and altered without departing from the sprit of the invention. The description in this document is only used for illustration but not to be construed as limiting. The scope of the invention is only limited by the claims.

1. A method for interference coordination by a femtocell, wherein there is at least one user terminal of a macrocell within coverage range of the femtocell, the method comprising:
the femtcell receiving a random access request initiated by the user terminal of the macrocell;
the femtcell estimating path loss between the femtocell and the user terminal of the macrocell; and
the femtcell performing interference coordination to ensure that the user terminal of the macrocell can receive information of control channels correctly.

2. The method according to claim 1, wherein the femtocell receiving a random access request initiated by the user terminal of the macrocell further comprises:
synchronizing the user terminal of the macrocell to the femtocell;
the user terminal of the macrocell receiving system information of the femtocell, the system information of the femtocell indicating that the user terminal of the macrocell can access the femtocell; and
the user terminal of the macrocell initiating the random access request to the femtocell.

3. The method according to claim 1, wherein the femtocell receiving a random access request initiated by the user terminal of the macrocell further comprises:
updating information settings of “whitelist of closed subscriber groups” of the user terminal of the macrocell to comprise all femtocells that potentially cause interferences to the user terminal of the macrocell;
synchronizing the user terminal of the macrocell to the femtocell; and
the user terminal of the macrocell initiating the random access request to the femtocell.

4. The method according to claim 1, wherein the femtocell receiving a random access request initiated by the user terminal of the macrocell further comprises:
synchronizing the user terminal of the macrocell to the femtocell; and
the user terminal of the macrocell receiving an instruction from a user to initiate the random access request to the femtocell.

5. (canceled)

6. (canceled)

7. (canceled)

8. The method according to claim 1, wherein the femtocell performs the interference coordination based on power control or time domain resource allocation.

9. (canceled)

10. A method for initiating a random access to a femtocell by a user terminal, wherein the user terminal is a user terminal of a macrocell and is located in coverage area of the femtocell, and the user terminal of the macrocell is an unauthorized user terminal for the femtocell, the method comprising:
the user terminal obtaining information allowing initiation of a random access request to the femtocell; and
the user terminal initiating the random access request to the femtocell.

11. The method according to claim 10, wherein the user terminal obtaining information allowing initiation of a random access request to the femtocell comprises: the user terminal receiving system information from the femtocell, the system information of the femtocell indicating that the user terminal of the macrocell can access the femtocell.

12. The method according to claim 10, wherein the user terminal obtaining information allowing initiation of a random access request to the femtocell comprises: information settings of “whitelist of closed subscriber groups” of the user terminal of the macrocell comprising all femtocells that potentially cause interferences to the user terminal of the macrocell.

13. The method according to claim 10, wherein the user terminal obtaining information allowing initiation of a random access request to the femtocell comprises: the user terminal receiving from a user an instruction which instructs the user equipment to initiate the random access request to the femtocell.

14. (canceled)

15. (canceled)

16. A femtocell, wherein there is at least one user terminal of a macrocell within coverage range of the femtocell, the femtocell comprising:
a synchronizing unit configured to receive synchronization information from the user terminal of the macrocell within the coverage range of the femtocell;
a receiving unit configured to receive a random access request initiated by the user terminal of the macrocell;
a path loss estimating unit configured to estimat path loss from the user terminal of the macrocell to the femtocell and path loss from the macrocell to the femtocell; and
an interference coordination unit configured to perform interference coordination to ensure that the user terminal of the macrocell can receive information of control channels correctly.

17. (canceled)

18. The femtocell according to claim 16, wherein the interference coordination unit performs the interference coordination based on power control or time domain resource allocation.

19. (canceled)

20. (canceled)

21. (canceled)

22. A user terminal equipment, which is within coverage range of a femtocell, the user terminal equipment comprising:
a detecting unit configured to detect whether initiation of a random access request is allowed; and
a random access request initiating unit configured to initiate the random access request to the femtocell when the detecting unit outputs information allowing initiation of a random access request.

23. The user terminal equipment according to claim 22, wherein:
the user terminal equipment further comprises a first receiving unit configured to receive system information from the femtocell; and
the detecting unit detects the system information from the femtocell and outputs to the random access request initiating unit the information allowing initiation of a random access request once it detects that the system information from the femtocell indicates that the user terminal of the macrocell can access the femtocell

24. The user terminal equipment according to claim 22, wherein:
the user terminal equipment further comprises a closed subscriber group whitelist storage unit configured to store whitelist of closed subscriber groups; and
settings of the closed subscriber group whitelist storage unit is updated to comprise all femtocells that potentially cause interferences to the user terminal of the macrocell; and
when the detecting unit detects that the whitelist of closed subscriber groups includes all femtocells that potentially cause interferences to the user terminal of the macrocell, it outputs to the random access request initiating unit the information allowing initiation of a random access request.

25. The user terminal equipment according to claim 22, wherein:
the user terminal equipment further comprises a second receiving unit configured to receive from a user an instruction which instructs the user equipment to initiate the random access request to the femtocell; and
when the detecting unit detects the instruction which instructs the user equipment to initiate the random access request to the femtocell, it outputs to the random access request initiating unit the information allowing initiation of a random access request.

26. (canceled)

27. (canceled)
